(19) United States
(12) Patent Application Publication
(10) Pub. No.: US 2013/0055771 A1
(43) Pub. Date: Mar. 7, 2013

(54) BRUSHLESS MOTOR FOR WASHING MACHINE AND DRUM-TYPE WASHING MACHINE PROVIDED WITH SAME

(71) Applicants: Yuichiro Tashiro, Osaka (JP); Hideaki Matsuo, Osaka (JP); Hideharu Hiwaki, Osaka (JP); Masahiko Morisaki, Osaka (JP)

(72) Inventors: Yuichiro Tashiro, Osaka (JP); Hideaki Matsuo, Osaka (JP); Hideharu Hiwaki, Osaka (JP); Masahiko Morisaki, Osaka (JP)

(73) Assignee: PANASONIC CORPORATION, Kadoma-shi, Osaka (JP)

(21) Appl. No.: 13/696,172

(22) PCT Filed: Jul. 20, 2011
(86) PCT No.: PCT/JP2011/004090

§ 371 Date: Nov. 5, 2012

(30) Foreign Application Priority Data
Jul. 21, 2010 (JP) 2010-163564

(51) Int. Cl. H02K 1/28; D06F 23/00; H02K 1/27

(52) U.S. Cl. 68/140; 310/43

(57) ABSTRACT

A brushless motor for washing machine of this invention is a motor suitable for application to a drum-type washing machine. The brushless motor for washing machine comprises a stator and a rotor. The stator includes a mounting section for fixing to a water tub, a stator core, a winding and a winding insulation material. The rotor includes a motor pulley for connection to a belt, a rotatably supported motor shaft, a rotor core and a magnet. At least one of the stator and the rotor has a mold portion formed of a resin material.

### TECHNICAL FIELD

The present invention relates to a brushless motor for washing machine used for a drum-type washing machine and the like, and a drum-type washing machine provided with the same.

### BACKGROUND ART

There are drum-type washing machines available as one type of washing machine that is provided with a rotary drum having an axis of rotation in a horizontal direction or an inclined direction, and power of a motor is transmitted to the rotary drum via a belt and a pulley.

Motors that have been used heretofore as applicable to drum-type washing machines of such type include brush motors (refer to PTL 1 for example) and induction motors (refer to PTL 2 for example). Laminated steel motors having frames of aluminum and the like materials have been used for these motors.

FIG. 11 is a drawing showing a general structure of a conventional drum-type washing machine discussed above. As shown in FIG. 11, conventional drum-type washing machine 50 comprises water tub 52 that rotatably supports rotary drum 51 having an axis of rotation in a horizontal direction or an inclined direction. Also provided behind water tub 52 are pulley 54 for transmitting power to rotary drum 51 via drum shaft 53 and motor 60 for transmitting the power to pulley 54 through belt 55. Generally, motor 60 is mounted under water tub 52, as shown in FIG. 11.

Conventional motor 60 comprises stator 61, a rotor (not shown) supported rotatably inside stator 61, motor shaft 62, output side bracket 63, contra-output side bracket 64 and so forth, and an iron part of stator 61 is exposed. In addition, it is a common configuration for brackets 63 and 64 to have openings so that their structures do not fully prevent ingress of water around the exterior surface of stator 61 and the interior of motor 60 (e.g., winding, rotor and bearings). Certain measures are therefore taken such as incorporating an ingenious shape of back surface of the water tub to make motor 60 not likely to get splashes of water.

In the conventional drum-type washing machine, however, it is difficult to make motor 60 absolutely free from splashes of water because motor 60 is mounted under water tub 52, thereby leaving a problem that formation of rust cannot be prevented completely with the conventional art. There is also a possibility of having a trouble such as a failure due to ark tracking since water being splashed on the winding is not completely avoidable.

In addition, there have been hitherto disclosed some techniques to prevent electrolytic corrosion liable to occur on motor bearings by forming a dielectric layer of insulation resin on a rotor core (refer to PTL 3 for example).

PTL 1: Japanese Patent Laid-Open Publication No. 2009-78056

PTL 2: Japanese Patent Laid-Open Publication No. 2009-297123

PTL 3: International Publication No. 2009/113311

### SUMMARY OF THE INVENTION

The present invention is to provide a brushless motor for washing machine, of which a stator core, a winding, a rotor core and the like components are sealed by molding them with a resin material to prevent a trouble due to formation of rust even when the motor is mounted under a water tub.

The brushless motor for washing machine of the present invention is a kind of brushless motor applicable to a drum-type washing machine provided with a rotary drum having an axis of rotation in a horizontal direction or an inclined direction, and power is transmitted to the rotary drum via a pulley and a belt. It has a structure provided with a mold portion formed of a resin material on at least one of a stator and a rotor, except that a gap surface located between the stator and the rotor is not sealed with the resin material because the rotor needs to be rotated.

A drum-type washing machine according to the present invention is provided with the brushless motor for washing machine of this invention.

By virtue of the above structure, the stator becomes such a configuration that it can prevent the winding carrying an electric current from being splashed with water, thereby avoiding such a trouble as arc tracking. It also prevents the stator core made of steel material from forming rust, and dispels any concern about performance degradation due to the rust.

As for the rotor, formation of rust does not occur on the rotor core for the same reason as the stator, and it hence dispels the concern about performance degradation. When a rare-earth magnet is used as the magnet, there arises a problem of characteristic degradation due particularly to the rust on the magnet. However, the concern about degradation of the magnetic characteristic also becomes unnecessary since the entire magnet is sealed with the resin material.

According to the present invention, at least one of the stator and the rotor is sealed by molding it with the resin material as described above, thereby providing the brushless motor for washing machine of high reliability and the drum-type washing machine equipped with the same motor.

### BRIEF DESCRIPTION OF THE DRAWINGS

FIG. 1 is a drawing showing a general structure of a drum-type washing machine equipped with a brushless motor for washing machine according to Exemplary Embodiment 1 of the present invention.

FIG. 2 is a drawing showing a structure of the brushless motor for washing machine according to Embodiment 1 of the present invention.

FIG. 3 is a perspective view of motor winding assembly of the brushless motor for washing machine according to Embodiment 1 of the present invention.

FIG. 4 is a structural drawing of a rotor of the brushless motor for washing machine according to Embodiment 1 of the present invention.

FIG. 5 is a drawing showing a structure of a brushless motor for washing machine according to Embodiment 2 of the present invention.

FIG. 6 is a structural drawing of a rotor of the brushless motor for washing machine according to Embodiment 2 of the present invention.

FIG. 7 is a drawing showing detailed sectional structure of a rotor core and a rotor mold portion of the brushless motor for washing machine according to Embodiment 2 of the present invention.

FIG. 8 is a drawing in a radial direction of the rotor core of the brushless motor for washing machine according to Embodiment 2 of the present invention.

FIG. 9 is a perspective view showing a structure of the rotor mold portion of the brushless motor for washing machine according to Embodiment 2 of the present invention.

FIG. 10 is a drawing showing a structure of a brushless motor for washing machine according to Embodiment 3 of the present invention.

FIG. 11 is a drawing showing a general structure of a drum-type washing machine equipped with a conventional motor.

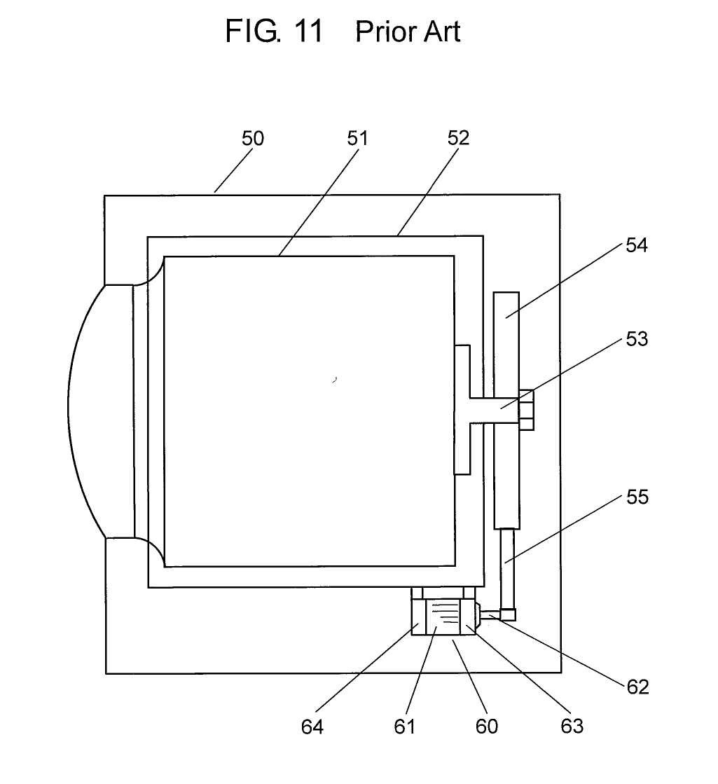

### DETAIL DESCRIPTION OF THE PREFERRED EMBODIMENTS

Referring to the accompanying drawings, description is provided hereafter of exemplary embodiments of the present invention.

### Exemplary Embodiment 1

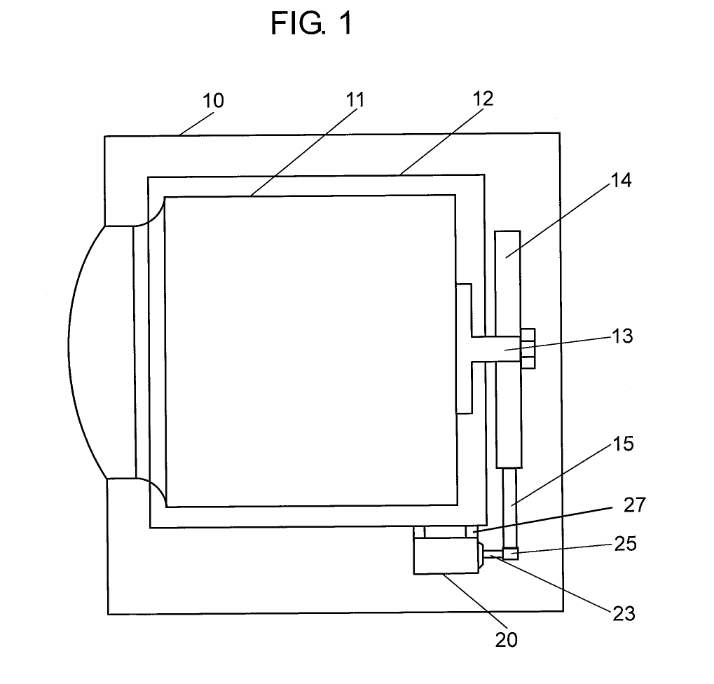

FIG. 1 is a drawing showing a general structure of a drum-type washing machine equipped with a brushless motor for washing machine according to Embodiment 1 of the present invention. As shown in FIG. 1, drum-type washing machine 10 is provided with water tub 12 that is supported elastically within a main body of the washing machine, and encloses therein and rotatably supports rotary drum 11 having an axis of rotation in a horizontal direction or an inclined direction. Also provided behind water tub 12 are pulley 14 for transmitting power to rotary drum 11 via drum shaft 13 and motor 20 for transmitting the power to pulley 14 through belt 15. Motor 20 used in this embodiment is a brushless motor in order to achieve a high efficiency. In this embodiment, motor 20 is fixed under water tub 12 via mounting section 27, as shown in FIG. 1.

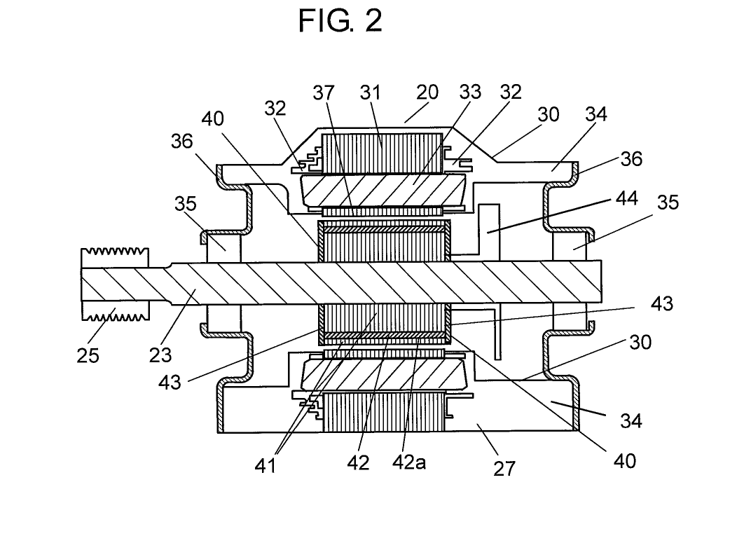

FIG. 2 is a drawing showing a structure of the brushless motor for washing machine according to Embodiment 1 of this invention. Description provided in this embodiment is a permanent-magnet type brushless motor equipped with permanent magnets, as an example of motor 20 representing this brushless motor for washing machine. Motor 20 comprises stator 30 fixed to water tub 12 of drum-type washing machine 10, and rotor 40 supported rotatably with respect to stator 30.

Stator 30 includes stator core 31, winding 33, stator mold portion 34, mounting section 27 and housing 36. Stator core 31 is formed of, for example, a stack of laminated steel sheets. Winding 33 is wound on stator core 31 through winding insulation material 32. Stator mold portion 34 is a molded part formed of a resin material on stator 30. Stator mold portion 34 encapsulates stator core 31, winding insulation material 32 and winding 33, except for gap surface 37 located between stator core 31 and rotor 40. Mounting section 27 is unitary formed with stator mold portion 34 by the resin material, and it is provided for fixing motor 20 to water tub 12. Housing 36 is fixed to stator mold portion 34, and it retains bearings 35.

Rotor 40 comprises motor shaft 23 supported rotatably by bearings 35 in the center, rotor core 41, magnets 42, end plates 43 and motor pulley 25. Rotor core 41 is formed of a stack of laminated steel sheets, and fixed to motor shaft 23 in generally the center portion of motor shaft 23. Magnets 42 are permanent magnets, and they are disposed inside rotor core 41. In other words, there are magnet insertion holes 42a formed in rotor core 41, and magnets 42 are inserted in magnet insertion holes 42a. FIG. 2 shows motor 20 of an IPM (Interior Permanent Magnet) type rotor that includes magnets 42 placed inside of rotor core 41. End plates 43 are disposed to both end surfaces in an axial direction of rotor core 41. Motor pulley 25 is fixed to one end of motor shaft 23 for transmitting power generated by rotor 40 to rotary drum 11. Motor pulley 25 is attached to the output-shaft side of motor shaft 23 that projects from a main body of the motor for connection with belt 15. The exemplary structure shown in FIG. 2 also includes fan blades 44 mounted to motor shaft 23 for cooling the interior of the motor.

Motor pulley 25 is designed to have a smaller outer diameter as compared to an outer diameter of pulley 14. For example, a pulley ratio obtained by dividing the outer diameter of pulley 14 by the outer diameter of motor pulley 25 is set to about 10 in order to achieve downsizing of motor 20 by reducing a torque required for motor 20 to generate. In other words, a rotational speed of motor 20 becomes 15,000 rpm when rotary drum 11 is to be rotated at a rotational speed of 1,500 rpm. In this embodiment, rotary drum 11 is driven to rotate at an optimum rotational speed by turning motor 20 at such a high speed.

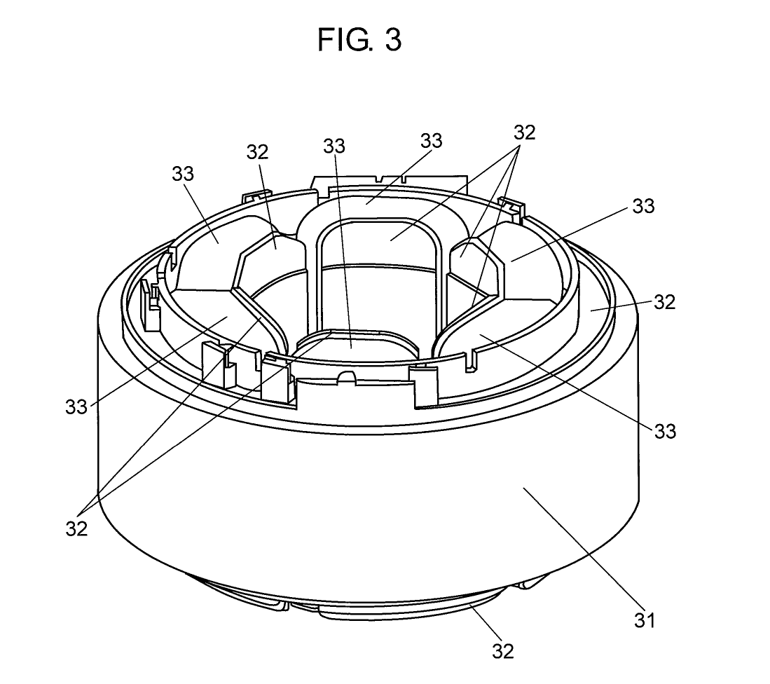

FIG. 3 is a perspective view of a motor winding assembly in a state that stator core 31, winding insulation material 32 and winding 33 shown in FIG. 2 are assembled together. As shown in FIG. 3, winding 33 is wound around stator teeth (not shown) with electrical insulation to stator core 31 provided by winding insulation material 32. Winding 33 consists of a combination of three phases, i.e., U, V and W, for instance, that produces a rotating magnetic field along an inner periphery of stator core 31 when energized with three-phase alternating currents. In this embodiment, the motor winding assembly shown in FIG. 3 is provided with stator mold portion 34 so formed as to encapsulate stator core 31, winding insulation material 32 and winding 33 with a resin material, except that the inner peripheral side of stator core 31, i.e., gap surface 37 where stator core 31 confronts rotor core 41, is left exposed. The structure thus composed is to eliminate any contact with the exterior space or the air.

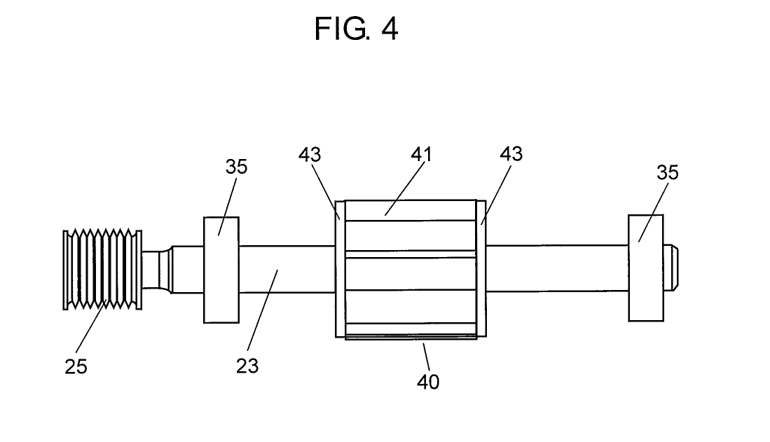

FIG. 4 illustrates rotor 40 and bearings 35 supporting motor shaft 23 shown in FIG. 2. According to this embodiment, end plates 43 are disposed individually to both the axial end surfaces of rotor core 41 as shown in FIG. 4, so that they prevent magnets 42 from coming out in the axial direction. Motor shaft 23 is inserted into rotor core 41, and rotatably supported by bearings 35. The power is transmitted to rotary drum 11 shown in FIG. 1 via motor pulley 25 attached to the end of motor shaft 23 and belt 15.

As described above, the brushless motor for washing machine according to Embodiment 1 of this invention has a structure, wherein stator 30 is provided with stator mold portion 34 formed in a manner to mold stator core 31, winding 33 and winding insulation material 32, except for gap surface 37 confronting rotor core 41. In other words, this structure encapsulates winding 33 carrying an electric current within stator mold portion 34 to avoid contact with water, as shown in FIG. 2 and FIG. 3. It can hence avoid such a trouble as arc tracking. Stator core 31 is also encapsulated inside stator mold portion 34 like winding 33, thereby dispelling any concern about performance degradation due to the rust of stator core 31, except for gap surface 37 that at all times confronts rotating rotor core 41. As a result, reliability of the brushless motor for washing machine can be improved. Since the drum-type washing machine of this invention is provided with the brushless motor as discussed above, reliability of the drum-type washing machine is also improved.

Although the description provided above in this embodiment is the IPM type rotor, the same advantageous effects are also achievable with other structures such as an SPM (Surface Permanent Magnet) type rotor having the magnets disposed to the surface of rotor core 41.

### Exemplary Embodiment 2

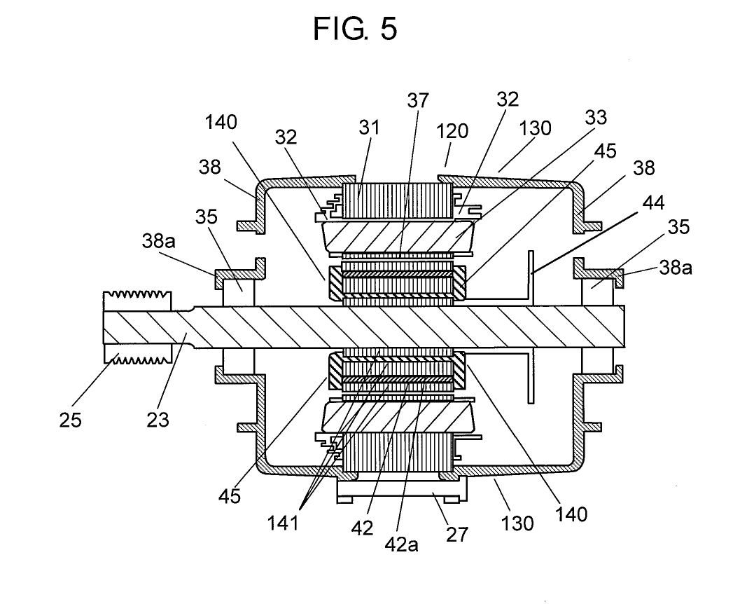

FIG. 5 is a drawing showing a structure of a brushless motor for washing machine according to Exemplary Embodiment 2 of this invention. The brushless motor for washing machine shown in FIG. 5 is also used for a drum-type washing machine in the same manner as the above Embodiment 1 shown in FIG. 1. In FIG. 5, components identical to those of Embodiment 1 are denoted by the same reference marks.

Motor 120 representing the brushless motor for washing machine of this embodiment comprises stator 130 fixed to water tub 12 of drum-type washing machine 10, and rotor 140 supported rotatably with respect to stator 130, as shown in FIG. 5.

Stator 130 comprises stator core 31, winding 33, stator frame 38 and mounting section 27. Stator core 31, winding insulation material 32 and winding 33 of this embodiment have the same structures as those shown in FIG. 3. Stator core 31 is formed of, for example, a stack of laminated steel sheets. Winding 33 is wound on stator core 31 through winding insulation material 32. Mounting section 27 is provided for the purpose of fixing motor 120 to water tub 12. Stator frame 38 retains stator core 31 and bearings 35, and it is fixed to water tub 12 via mounting section 27. Although the structure shown in FIG. 5 is an example wherein housing 38a retains bearings 35, and stator frame 38 and housing 38a are integrated into one unit, it is also possible to make stator frame 38 and housing 38a as separate components.

Rotor 140 comprises motor shaft 23 supported rotatably by bearings 35 in the center, rotor core 141, magnets 42, rotor mold portion 45 and motor pulley 25. Rotor core 141 is formed of a stack of laminated steel sheets, for instance, and fixed to motor shaft 23 in generally the center portion of motor shaft 23. Magnets 42 are inserted in magnet insertion holes 42a formed in rotor core 141 and so disposed inside rotor core 141. In other words, the structure shown in this embodiment is also a typical example of the IPM type rotor. Rotor mold portion 45 is a molded part formed on rotor 140. Rotor mold portion 45 covers both end surfaces in the axial direction of rotor core 141 in a manner to sandwich both the surfaces of rotor core 141 and encapsulate magnets 42 within rotor core 141, except that gap surface 37 where rotor core 141 confronts stator core 31 is left exposed. Motor pulley 25 is fixed to one end of motor shaft 23 for transmitting power generated by rotor 140 to rotary drum 11. Motor pulley 25 is attached to the output-shaft side of motor shaft 23 that projects from a main body of the motor for connection with belt 15. Similar to Embodiment 1, motor pulley 25 is designed to have a smaller outer diameter as compared to an outer diameter of pulley 14.

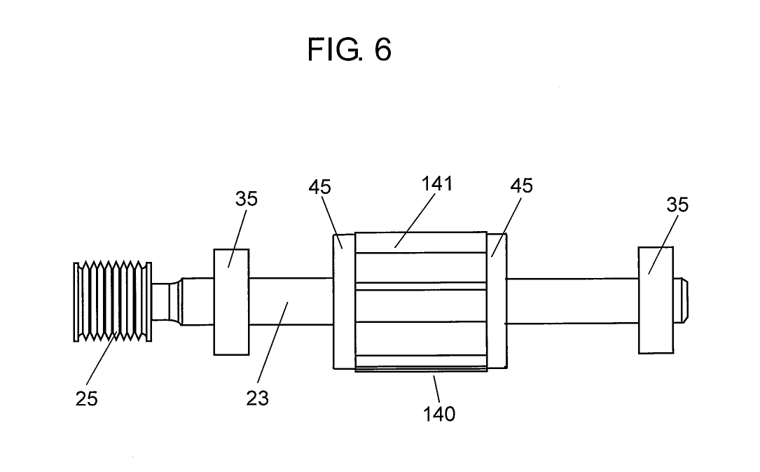

FIG. 6 shows rotor 140 including motor pulley 25, and bearings 35 disposed to rotor 140. Motor shaft 23 is inserted into rotor core 141, and rotatably supported by bearings 35. The power is transmitted to rotary drum 11 shown in FIG. 1 via motor pulley 25 attached to the end of motor shaft 23. Rotor 140 is so constructed as to include rotor mold portion 45 formed on both the end surfaces in the axial direction of rotor core 141. Rotor mold portion 45 is formed by molding a resin material. The interior and both the end surfaces of rotor core 141 are sealed by rotor mold portion 45.

As described above, the brushless motor for washing machine according to Embodiment 2 of this invention is provided with rotor mold portion 45 on both the end surfaces of rotor core 141 in a manner to encapsulate rotor core 141 and magnets 42, except for gap surface 37 confronting stator core 31. In other words, magnets 42 are encapsulated within rotor core 141 as stated above, thus used is the IPM type rotor. Rotor mold portion 45 is so formed as to completely cover both ends of magnets 42. The structure so composed in this embodiment prevents magnets 42 from coming out of rotor core 141 in the axial direction without using any extra component such as an end plate that involves an additional weight and increase in the cost. This structure can also prevent magnets 42 from coming in contact with water.

There are often cases that rare earth magnets of a neodymium-iron-boron group material are applied as magnets 42, especially for the motor used in a drum-type washing machine, because of the need to reduce the size while maintaining a high torque. The rare earth magnets of the neodymium-iron-boron group material has a drawback of becoming degraded by rust, in spite of the advantage of high residual magnetic flux density that helps increase the motor torque. Magnets 42 are therefore encapsulated entirely inside rotor core 141 by sealing both end surfaces of rotor core 141 with rotor mold portion 45, as shown in FIG. 6. It hence prevents water from wetting magnets 42, and dispels the concern about aged degradation in the characteristic of magnets 42 due to the rust, thereby providing the brushless motor for washing machine of low characteristic degradation with aging and high reliability.

Description is provided next of the structure of rotor 140 in more detail.

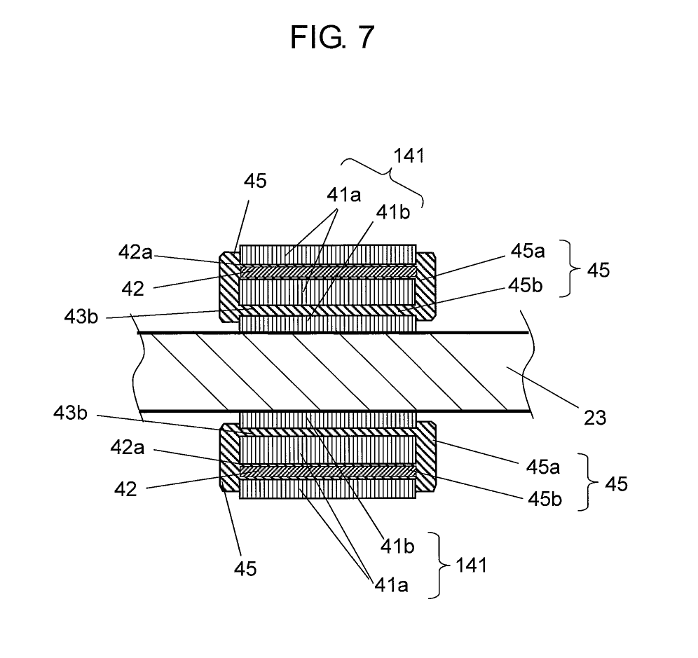

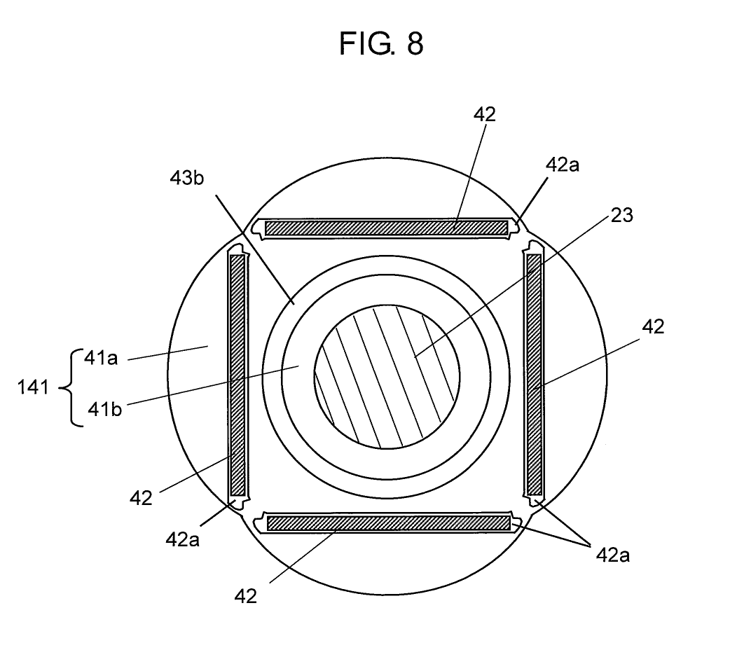

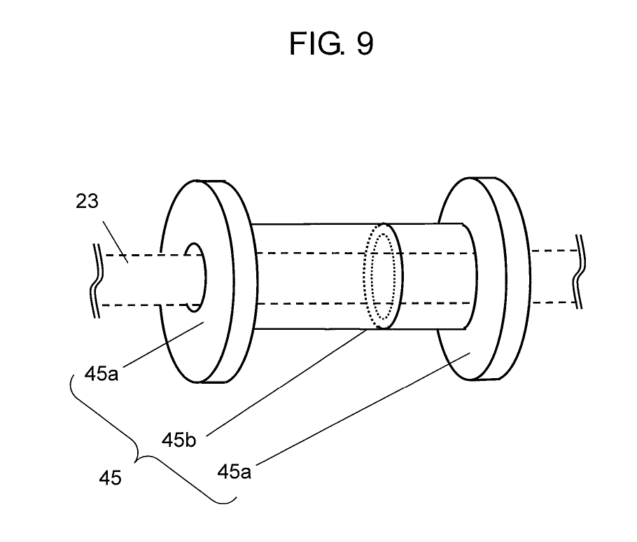

FIG. 7 is a drawing showing detailed sectional structure of rotor core 141 and rotor mold portion 45 shown in FIG. 5, and FIG. 8 is a drawing in a radial direction of rotor core 141. FIG. 9 is a perspective view showing the structure of rotor mold portion 45.

As shown in FIG. 7, motor shaft 23 is inserted in the center of rotor core 141. There are a plurality of magnet insertion holes 42a formed in rotor core 141, and magnets 42 are inserted in individual magnet insertion holes 42a as shown in FIG. 8. FIG. 8 shows an example in which four magnets 42 are disposed. Besides the rare earth magnets of the neodymium-iron-boron group material, other kinds of magnets such as ferrite magnets and resin-molded magnets are also suitable for use as magnets 42.

In addition, rotor core 141 has through-hole 43b formed therein. Through-hole 43b is such a hole that penetrates through rotor core 141 in the axial direction as shown in FIG. 7, and it has an annular shape in the radial direction as shown in FIG. 8. In other words, through-hole 43b is formed into a space of cylindrical shape inside rotor core 141 and extending from one of the end surfaces to the other end surface.

In this embodiment, a part of rotor mold portion 45 is disposed inside through-hole 43b of such shape. That is, rotor mold portion 45 has a structure unitarily connecting resin end portions 45a disposed on both the end surfaces of rotor core 141 and resin extension portion 45b of the cylindrical shape, as shown in FIG. 9. Resin extension portion 45b is thus formed to fill in through-hole 43b and disposed inside rotor core 141.

On the other hand, rotor core 141 is separated into outer rotor core 41a and inner rotor core 41b by resin extension portion 45b since resin extension portion 45b is formed into the cylindrical shape as is obvious from FIG. 7 and FIG. 8. That is, outer rotor core 41a is located in the outer side of resin extension portion 45b, and inner rotor core 41b is located in the inner side of resin extension portion 45b. Resin extension portion 45b is formed of a resin material that is an electrical insulator. Therefore, outer rotor core 41a and inner rotor core 41b are insulated to DC current, whereas a high-frequency current flows between outer rotor core 41a and inner rotor core 41b. Rotor core 141 is separated into outer rotor core 41a and inner rotor core 41b as such that they are electrically insulated by resin extension portion 45b. By including the above structure in this embodiment, an impedance of rotor 140 is increased to approximate it to a high impedance of stator 130 described, for instance, in the above-referred PTL 3. This structure decreases a difference in voltage potential between an outer ring and an inner ring of bearing 35, and retards evolution of electrolytic corrosion.

As has been described, resin end portions 45a are disposed in contact with rotor core 141, and they cover both the end surfaces in the axial direction of rotor core 141 in a manner to seal both of the end surfaces of rotor core 141. This is to prevent magnets 42 from coming out of magnet insertion holes 42a, and also prevent rotor core 141 and magnets 42 from forming rust by avoiding ingress of water. Moreover, resin end portions 45a can be disposed and fixed to both the end surfaces of rotor core 141 without using any of screw and adhesive because of the structure of connecting resin end portions 45a at both ends with resin extension portion 45b, in addition to the effect provided by resin extension portion 45b to retard evolution of electrolytic corrosion.

In order to form rotor mold portion 45 of the structure of FIG. 9 on rotor core 141, a thermosetting resin or the like can be used to mold integrally with outer rotor core 41a and inner rotor core 41b, for instance, without setting motor shaft 23 in place. Since rotor mold portion 45 has the structure comprising resin end portions 45a at both ends and resin extension portion 45b connected into a single unit, rotor core 141 and rotor mold portion 45 can be integrated by a single process of molding to easily form the integrated assembly. Rotor 140 can be completed by inserting the integrated assembly of rotor core 141 and rotor mold portion 45 as well as motor pulley 25 to motor shaft 23.

Since the drum-type washing machine of this invention is provided with the brushless motor of above type, reliability of the drum-type washing machine can also be improved.

### Exemplary Embodiment 3

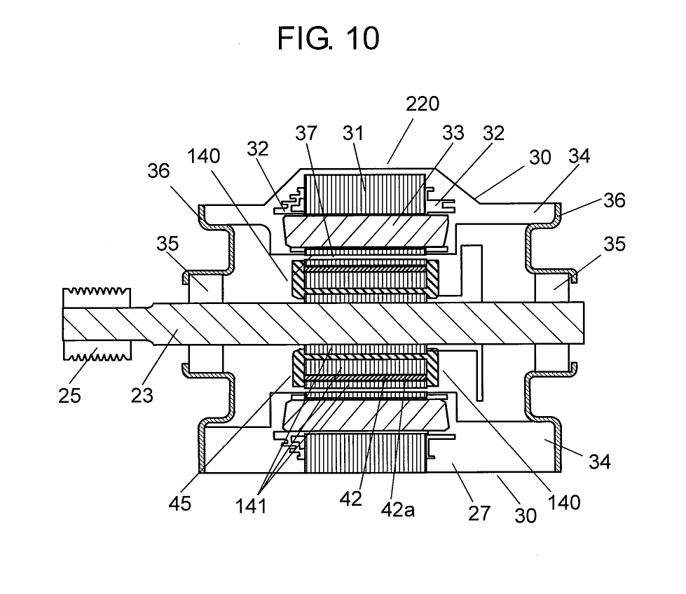

FIG. 10 is a drawing showing a structure of a brushless motor for washing machine according to Embodiment 3 of the present invention. The brushless motor for washing machine shown in FIG. 10 is also used for a drum-type washing machine in the same manner as the above Embodiments 1 and 2 shown in FIG. 1. In FIG. 10, components identical to those of Embodiments 1 and 2 are denoted by the same reference marks.

Motor 220 representing the brushless motor for washing machine of this embodiment comprises stator 30 fixed to water tub 12 of drum-type washing machine 10, and rotor 140 supported rotatably with respect to stator 30, as shown in FIG. 10.

Stator 30 is identical to that of Embodiment 1 and it comprises stator core 31, winding 33, stator mold portion 34, mounting section 27 and housing 36. Stator core 31 is formed of, for example, a stack of laminated steel sheets. Winding 33 is wound on stator core 31 through winding insulation material 32. Stator mold portion 34 is a molded part formed of a resin material on stator 30. Stator mold portion 34 encapsulates stator core 31, winding insulation material 32 and winding 33, except for gap surface 37 formed between stator core 31 and rotor 140. Housing 36 is fixed to stator mold portion 34, and it retains bearings 35.

Rotor 140 is identical to that of Embodiment 2 and it comprises motor shaft 23 supported rotatably by bearings 35 in the center, rotor core 141, magnets 42, rotor mold portion 45 and motor pulley 25. Rotor core 141 is formed of a stack of laminated steel sheets, for instance, and fixed to motor shaft 23 in generally the center portion of motor shaft 23. Magnets 42 are inserted in magnet insertion holes 42a formed in rotor core 141, and disposed inside rotor core 141. Rotor mold portion 45 is a molded part formed on rotor 140. Rotor mold portion 45 covers both end surfaces in the axial direction of rotor core 141 in a manner to sandwich both the surfaces of rotor core 141 and encapsulate magnets 42 within rotor core 141, except that it exposes gap surface 37 where rotor core 141 confronts stator core 31. Motor pulley 25 is fixed to one end of motor shaft 23 for transmitting power generated by rotor 140 to rotary drum 11.

Rotor 140 has the structure shown in FIG. 7, FIG. 8 and FIG. 9 like that of Embodiment 2.

In short, stator 30 has identical structure as Embodiment 1, and rotor 140 has identical structure as Embodiment 2.

The brushless motor for washing machine according to Embodiment 3 of this invention has a structure, wherein stator 30 is provided with stator mold portion 34 formed in a manner to mold stator core 31, winding 33 and winding insulation material 32, except for gap surface 37 confronting rotor core 141. In addition, rotor 140 is provided with rotor mold portion 45 on both the end surfaces of rotor core 141 in a manner to mold rotor core 141 and magnets 42, except for gap surface 37 confronting stator core 31.

By adopting the above structure, winding 33 carrying an electric current is encapsulated within stator mold portion 34 to prevent it from being exposed to water, thereby avoiding such a trouble as arc tracking, as obvious from Embodiments 1 and 2. The structure also dispels any concern about performance degradation due to formation of rust on stator core 31. In addition, complete encapsulation of magnets 42 by rotor mold portion 45 can prevent magnets 42 form coming out of rotor core 141 in the axial direction, and avoid water from wetting magnets 42. Since the above structure dispels the concern about degradation in the characteristic of magnets 42 due to the rust, it can provide the brushless motor for washing machine of low degradation in the characteristic with aging and high reliability.

Furthermore, since resin end portions 45a on both the ends of rotor core 141 are connected with resin extension portion 45b, resin end portions 45a can be disposed and fixed to both the ends of rotor core 141 without using any of screw and adhesive, and resin extension portion 45b can also retard evolution of electrolytic corrosion. In addition, since rotor mold portion 45 has the structure comprising resin end portions 45a at both the ends of rotor core 141 and resin extension portion 45b connected into a single unit, the integrated assembly of rotor core 141 and rotor mold portion 45 can be formed easily.

Furthermore, reliability of a drum-type washing machine of this invention can be improved since the drum-type washing machine is equipped with the brushless motor of above type.

As described above, stator mold portion 34 and rotor mold portion 45 are required to have a high resistance to tracking. Therefore, the resin material for molding preferably has superior electrical insulation property and high resistance to tracking, and it is especially desirable that such a molding resin is selected from a group consisting of thermosetting resins such as unsaturated polyester resin, epoxy resin and diallyl-phthalate resin, and thermoplastic resins such as polybutyrene terephthalate. Compounding ingredients may also be added to the molding resin if necessary, including inorganic materials such as calcium carbonate, calcium silicate, talc, kaolin, mica, titanium oxide, alumina, silica and other compounding agents. Injection molding featuring high precision forming is preferably used as the molding method in order to reduce variation in the amount of the resin to the smallest extent possible in the process of molding.

### INDUSTRIAL APPLICABILITY

The brushless motor for washing machine of the present invention can improve safety and reliability since a stator core and winding are sealed by using a resin material. In addition, aged degradation of the motor performance can also be prevented by sealing a magnet in the rotor core with a resin material, thereby providing the motor with high reliability and high performance. The motor is therefore suitable for such an application as household appliance being used in or near a wet area that requires high reliability and high performance, as represented specifically by a drum-type washing machine.

### REFERENCE MARKS IN THE DRAWINGS

10, 50 Drum-type washing machine
11, 51 Rotary drum
12, 52 Water tub
13, 53 Drum shaft
14, 54 Pulley
15, 55 Belt
20, 60, 120, 220 Motor
23, 62 Motor shaft
25 Motor pulley
30, 61, 130 Stator
31 Stator core
32 Winding insulation material
33 Winding
34 Stator mold portion
35 Bearing
36, 38a Housing
38 Stator frame
40, 140 Rotor
41, 141 Rotor core
41a Outer rotor core
41b Inner rotor core
42 Magnet
42a Magnet insertion hole
43 End plate
43b Through-hole
44 Fan blade
45 Rotor mold portion
45a Resin end portion
45b Resin extension portion
63 Output side bracket
64 Contra-output side bracket

1. A brushless motor for washing machine suitable for a drum-type washing machine provided with a rotary drum having an axis of rotation in one of a horizontal direction and an inclined direction, a water tub containing the rotary drum, a pulley for transmitting power to the rotary drum through a drum shaft, and the motor for driving the rotary drum by transmitting the power to the pulley via a belt, wherein the brushless motor comprises:
a stator having a mounting section to be fixed to the water tub, a stator core, a winding and a winding insulation material; and
a rotor having a motor pulley to be connected to the belt, a rotatably supported motor shaft, a rotor core and a magnet, wherein
at least one of the stator and the rotor includes a mold portion formed of a resin material.

2. The brushless motor for washing machine of claim 1 wherein:
at least the stator has the mold portion; and
the mold portion of the stator is provided in a manner to mold the stator core, the winding and the winding insulation material, except for a gap surface confronting the rotor core.

3. The brushless motor for washing machine of claim 1 wherein:
at least the rotor has the mold portion; and
the mold portion of the rotor is provided on both end surfaces of the rotor core in a manner to mold the rotor core and the magnet, except for a gap surface confronting the stator core.

4. The brushless motor for washing machine of claim 3 wherein:
the rotor core has a magnet insertion hole penetrating therethrough in an axial direction of the motor shaft;
the magnet is inserted in the magnet insertion hole; and
the mold portion of the rotor is provided on both end surfaces in the axial direction of the rotor core in a manner to cover both ends of the magnet inserted in the magnet insertion hole.

5. The brushless motor for washing machine of claim 3 wherein the rotor core has a through-hole penetrating therethrough in an axial direction of the motor shaft; and
the mold portion of the rotor is formed into a unitary structure connecting resin end portions disposed on both the end surfaces of the rotor core and a resin extension portion disposed to extend in the through-hole.

6. The brushless motor for washing machine of claim 5 wherein the rotor core comprises an outer rotor core and an inner rotor core that are separated and electrically insulated by the resin extension portion.

7. The brushless motor for washing machine of claim 5 wherein the through-hole penetrates in a cylindrical shape through inside of the rotor core, and the resin extension portion is formed to fill in the through-hole.

8. A drum-type washing machine comprising a rotary drum, a water tub, a pulley and the brushless motor for washing machine as recited in claim 1, wherein the brushless motor is fixed under the water tub via the mounting section.

9. A drum-type washing machine comprising a rotary drum, a water tub, a pulley and the brushless motor for washing machine as recited in claim 2, wherein the brushless motor is fixed under the water tub via the mounting section.

10. A drum-type washing machine comprising a rotary drum, a water tub, a pulley and the brushless motor for washing machine as recited in claim 3, wherein the brushless motor is fixed under the water tub via the mounting section.

11. A drum-type washing machine comprising a rotary drum, a water tub, a pulley and the brushless motor for washing machine as recited in claim 4, wherein the brushless motor is fixed under the water tub via the mounting section.

12. A drum-type washing machine comprising a rotary drum, a water tub, a pulley and the brushless motor for washing machine as recited in claim 5, wherein the brushless motor is fixed under the water tub via the mounting section.

13. A drum-type washing machine comprising a rotary drum, a water tub, a pulley and the brushless motor for washing machine as recited in claim 6, wherein the brushless motor is fixed under the water tub via the mounting section.

14. A drum-type washing machine comprising a rotary drum, a water tub, a pulley and the brushless motor for washing machine as recited in claim 7, wherein the brushless motor is fixed under the water tub via the mounting section.
